(19) United States
(12) Patent Application Publication
(10) Pub. No.: US 2008/0110514 A1
(43) Pub. Date: May 15, 2008

(54) Fuel Tank System

(76) Inventor: Naohiro Yoshida, Aichi (JP)

Correspondence Address: KENYON & KENYON LLP, 1500 K STREET N.W., SUITE 700, WASHINGTON, DC, 20005, US

(21) Appl. No.: 11/794,293

(22) PCT Filed: Jan. 26, 2006
(86) PCT No.: PCT/JP06/01706

§ 371 Date: Jun. 27, 2007

(30) Foreign Application Priority Data
Jan. 26, 2005 (JP) 2005-017821

(51) Int. Cl. F17C 13/04

(52) U.S. Cl. 137/628

(57) ABSTRACT

Disclosed is a fuel tank system capable of suppressing stagnation of fuel between check valves arranged in a fuel filling path. The fuel tank system has the fuel filling path which supplies fuel to a fuel tank through a filling port, and at least two check valves arranged in series in the fuel filling pat. The valve opening pressure of one check valve arranged on the fuel tank side is set to be smaller than that of the other check valve arranged on the filling port side.

### TECHNICAL FIELD

The present invention relates to a fuel tank system to be filled with fuel gas for use.

### BACKGROUND ART

In a system in which a fuel tank is used, the fuel tank is once filled with fuel gas, and then the gas is gradually supplied to a fuel consumption device depending on a load amount.

Heretofore, as such a fuel tank system, there is a system disclosed in, for example, Japanese Utility Model Registration Publication No. 3090448 (Patent Document 1). In this publication, a filling port communicates with the fuel tank via a filling pipe line on which two check valves are installed. According to this system, it can be prevented that the closing operation characteristic in the check valves become impervious in its operation characteristic to a differential pressure generated during generation of a swirling motion of a gas.

### DISCLOSURE OF THE INVENTION

However, when a plurality of check valves are provided in the system, fuel gas becomes stagnant between the check valves of a fuel filling path and between the check valve and the fuel tank. Therefore, the fuel gas which is stagnant in these sections cannot effectively be used.

Moreover, even in a case where the fuel gas which has become stagnant in the fuel filling path is eventually used up, as a plurality of check valves are arranged, a section where an inner pressure of a pipe line does not drop appears. Therefore, defect in sealing of the valves cannot be correctly detected.

To solve the problem, an object of the present invention is to provide a fuel tank system capable of suppressing any stagnation of fuel which might occur between check valves. According to one aspect of the present invention, an object thereof is to provide a fuel tank system capable of effectively using fuel gas which has stagnated in a fuel filling path. Furthermore, according to another aspect of the present invention, an object thereof is to provide a fuel tank system in which occurrence of any defect of a valve can correctly be detected.

To achieve the above object, a fuel tank system according to the present invention has a fuel filling path to supply fuel to a fuel tank through a filling port, and at least two check valves arranged in series in the fuel filling path. A valve opening pressure of one check valve arranged on the fuel tank side is set to be smaller than that of the other check valve arranged on the filling port side.

According to the configuration, the check valve arranged on a downstream side (the fuel tank side) opens at a pressure smaller than that of the check valve arranged on an upstream side (the filling port side). In consequence, after completion of filling of the fuel, when the pressure of the fuel filling path drops, the check valve on the upstream side closes prior to the other check valve and therefore, the fuel gas which has become stagnant between the check valves is discharged to the fuel filling path on the downstream side via the check valve on the downstream side which has not been closed yet. Therefore, fuel gas can be inhibited from stagnating between the check valves.

Here, in a case where the “fuel” to be supplied to the fuel tank is a liquid fuel, the fuel gas is a gas generating due to evaporation from the liquid fuel. On the other hand, in a case where the “fuel” to be supplied to the fuel tank is a gaseous fuel, the fuel gas is that gaseous fuel. Examples of this type of liquid fuel include liquid hydrogen or a liquefied natural gas. Examples of this type of gaseous fuel include a hydrogen gas and a natural gas.

Here, the valve opening pressure of the check valve is a minimum operating pressure or a cracking pressure of the check valve.

At least the two check valves may be two check valves arranged in the vicinity of the filling port, or two check valves arranged in the vicinity of the fuel tank.

Preferably, the fuel tank system of the present invention further includes a fuel consumption device which consumes the fuel; a fuel supply path which allows the fuel consumption device to communicate with the fuel filling path; and a first shut-off valve arranged in the fuel supply path. Moreover, the first shut-off valve is opened by an inner pressure of the fuel filling path. According to this system, in a case where the fuel gas between the check valves is discharged, the inner pressure of the fuel filling path increases to a certain degree, and the first shut-off valve is opened in response to this inner pressure. In consequence, the fuel gas which resides in the fuel filling path is supplied to the fuel consumption device via the fuel supply path, and can effectively be consumed. Here, the first shut-off valve may be not only one valve means but also a plurality of valves.

More preferably, the fuel supply path is connected to the fuel filling path on a downstream side of at least the two check valves. In consequence, the fuel gas discharged between the check valves can securely be supplied to the fuel supply path.

Preferably, the first shut-off valve is opened by the inner pressure of the fuel filling path between at least the two check valves. According to another preferable aspect, the first shut-off valve may be opened by the inner pressure of the fuel filling path on the downstream side of at least the two check valves.

According to one aspect of the present invention, in a case where the fuel is a liquid fuel and the fuel tank is a liquid fuel tank to store the liquid fuel, the fuel tank system may further include a gas fuel tank to store a gaseous fuel evaporated from the liquid fuel stored in the liquid fuel tank; and a filling path which allows the liquid fuel tank to communicate with the gas fuel tank and which fills the gas fuel tank with the gas fuel from the liquid fuel tank. Moreover, the fuel supply path may have a supply path which allows the gas fuel tank to communicate with the fuel consumption device, and the fuel consumption device is configured to consume the gaseous fuel. According to such a constitution, in a system for combined use of the liquid fuel and the gaseous fuel, the gaseous fuel evaporated from the liquid fuel in the fuel filling path can effectively be inhibited from residing between the check valves.

Preferably, a plurality of gas fuel tanks are arranged, the filling path allows the liquid fuel tank to communicate with the plurality of gas fuel tanks, and the supply path allows the plurality of gas fuel tanks to communicate with the fuel consumption device. In consequence, while suppressing stagnation of the gaseous fuel between the check valves, a large amount of the gaseous fuel can be stored.

Preferably, the first shut-off valve is closed based on a pressure of the supply path.

Moreover, the first shut-off valve may be closed based on a pressure of the fuel supply path or a valve opened time of the first shut-off valve. Once the fuel gas is supplied from the first shut-off valve to the fuel supply path, the pressure in the fuel supply path changes. Since a volume of the fuel filling path is usually limited, a supply time of the residual fuel gas is comparatively short. In this respect, according to the present invention, the first shut-off valve is appropriately closed based on the pressure change of the fuel supply path and the supply time of the fuel gas.

Preferably, the fuel tank system of the present invention further includes: a second shut-off valve arranged at an inlet of the fuel tank in the fuel filling path; and a control unit which determines whether or not the second shut-off valve is defective based on an inner pressure between the check valve arranged on the fuel tank side and the second shut-off valve, in a case where reduction in a pressure of the fuel filling path is completed by opening or closing the first shut-off valve. If any defect occurs in the second shut-off valve, there is a possibility that the fuel gas leaks from the fuel tank and flows backward to change the inner pressure of the fuel filling path. A value of this inner pressure can be monitored to detect occurrence of defect of the second shut-off valve.

According to one preferable aspect, the fuel tank system of the present invention may include a control unit which determines whether or not the check valve arranged on the downstream side of the fuel filling path is defective based on an inner pressure between the adjacently or continuously arranged check valves, when reduction in the pressure of the fuel filling path is completed by opening or closing the first shut-off valve. The check valve is shut off, when the stagnant fuel gas is expelled and the pressure drops below the valve opening pressure. However, if any defect occurs in the check valve, the inner pressure between the check valves rises even after the stagnant fuel gas is released. The defect of the check valve on the downstream side can be detected based on this inner pressure between the check valves.

Moreover, the fuel tank system of the present invention may take the following various preferable aspects.

Preferably, at least the two check valves comprise at least one check valve attached to the fuel tank, and at least one check valve arranged at a position away from the fuel tank. At least one check valve is attached to the fuel tank. Therefore, even if the fuel flows backward from the fuel tank, this counter flow can be inhibited or suppressed in the vicinity of the fuel tank. Here, the “position away from the fuel tank” means that the valve is not attached to the fuel tank, and is, for example, a position close to the filling port along the fuel filling path.

Preferably, at least one check valve attached to the fuel tank is incorporated in a valve assembly connected to a mouthpiece of the fuel tank. In consequence, handling of the check valve can be improved.

Preferably, a plurality of fuel tanks is arranged.

Preferably, the fuel is a gaseous fuel. In consequence, the gaseous fuel is stored in the fuel tank, and the gaseous fuel flows through the fuel filling path.

Preferably, the fuel tank system comprises a fuel cell which consumes the gaseous fuel, and a supply path which allows the fuel cell to communicate with the fuel tank. Therefore, the fuel tank system is applicable to a fuel cell system.

According to the fuel tank system of the present invention described above, stagnation of the fuel between the check valves can be suppressed.

### BRIEF DESCRIPTION OF THE DRAWINGS

FIG. 1 is a block diagram of a fuel cell system of an embodiment on which a fuel tank system is mounted according to a first embodiment of the present invention;

FIG. 2 is a flow chart showing a fuel tank residual gas use process according to the first embodiment of the present invention;

FIG. 3 is a block diagram of a fuel cell system of an embodiment on which a fuel tank system is mounted according to a second embodiment of the present invention; and

FIG. 4 is a cross-sectional view schematically showing a part of a fuel tank according to the second embodiment of the present invention.

### BEST MODE FOR CARRYING OUT THE INVENTION

A preferable embodiment of the present invention will be described with reference to the drawings. The following embodiment is an illustration of the present invention. The present invention is not limited to the following embodiment, and may variously be modified and carried out.

### First Embodiment

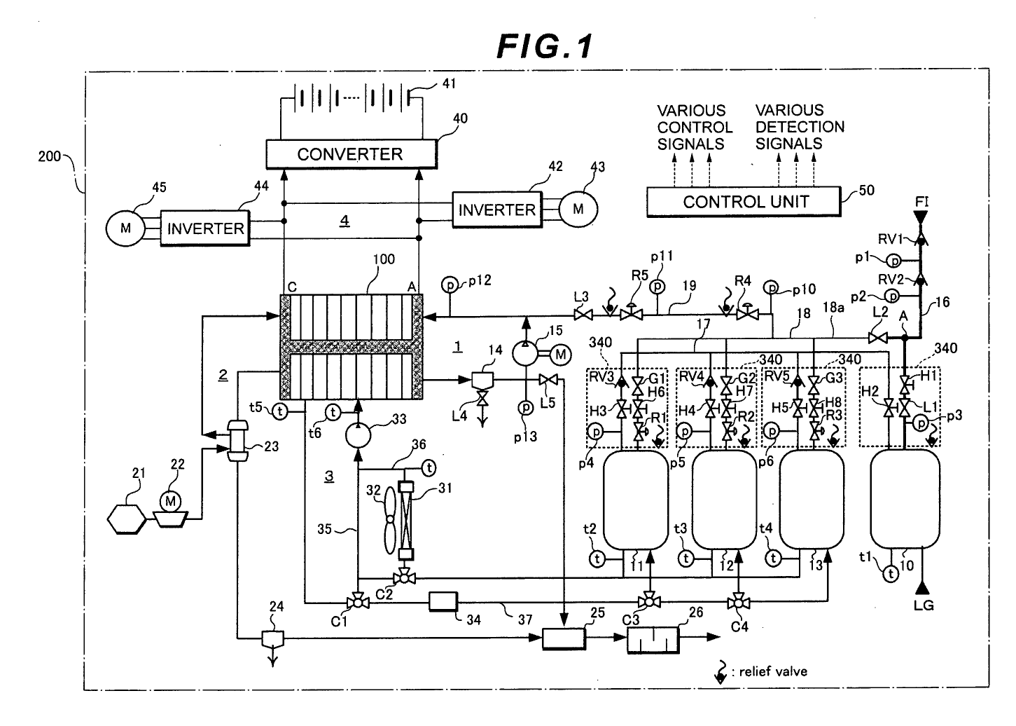

FIG. 1 is a system block diagram of a fuel cell system to which a fuel tank system of the present invention is applied. A fuel cell system 200 is mounted on a mobile object such as a car, includes a plurality of filling tanks 11 to 13 as filling means for filling with a boil-off gas generated as a fuel gas from liquid hydrogen, and is constituted so that volumes of the filling tanks 11 to 13 can be changed in accordance with an amount of the boil-off gas.

As shown in FIG. 1, the present fuel cell system 200 includes a hydrogen gas supply system 1 which supplies a hydrogen gas as the fuel gas to a fuel cell stack 100, an air supply system 2 which supplies air as an oxidation gas to the stack, a cooling system 3 which cools the fuel cell stack 100, a power system 4 which charges or discharges power generated by the fuel cell stack 100 and a control unit 50 which controls the whole system.

The hydrogen gas supply system 1 is mainly constituted of a fuel tank 10 and the filling tanks 11 to 13 so that the boil-off gas generated as the fuel gas from liquid hydrogen can be filled and supplied. That is, the hydrogen gas supply system 1 fills the fuel tank 10 as a liquid fuel tank with liquid hydrogen which is the liquid fuel, and fills the filling tanks 11 to 13 with the fuel gas (the boil-off gas) which is a gaseous fuel evaporated from liquid hydrogen stored in the fuel tank 10. Moreover, the hydrogen gas supply system 1 supplies the fuel gas stored in these filling tanks 11 to 13 to the fuel cell stack 100. The fuel gas of the filling tanks 11 to 13 is stored at a high pressure (e.g., 35 MPa), the pressure of the gas is reduced with a regulation valve or the like described later in a stepwise manner, and the gas is supplied to the fuel cell stack 100 in a pressure state of approximately 1 MPa.

The fuel tank 10 includes a double vacuum structure, and is capable of storing liquid hydrogen having a remarkably low boiling point (of about 20 K). The tank also includes a pressure-resistant structure in which the boil-off gas generated from this liquid hydrogen can be stored at a high pressure of a certain degree. The fuel tank 10 is provided with a relief valve for lowering an inner pressure in a case where the inner pressure remarkably rises. The fuel tank 10 is also provided with a level gauge LG for checking an amount of the liquid fuel which resides in a liquid phase so that the gauge is readable by the control unit 50. A liquid surface position of the liquid fuel can be measured for the control unit 50 to grasp the amount of the liquid fuel which is present as a liquid.

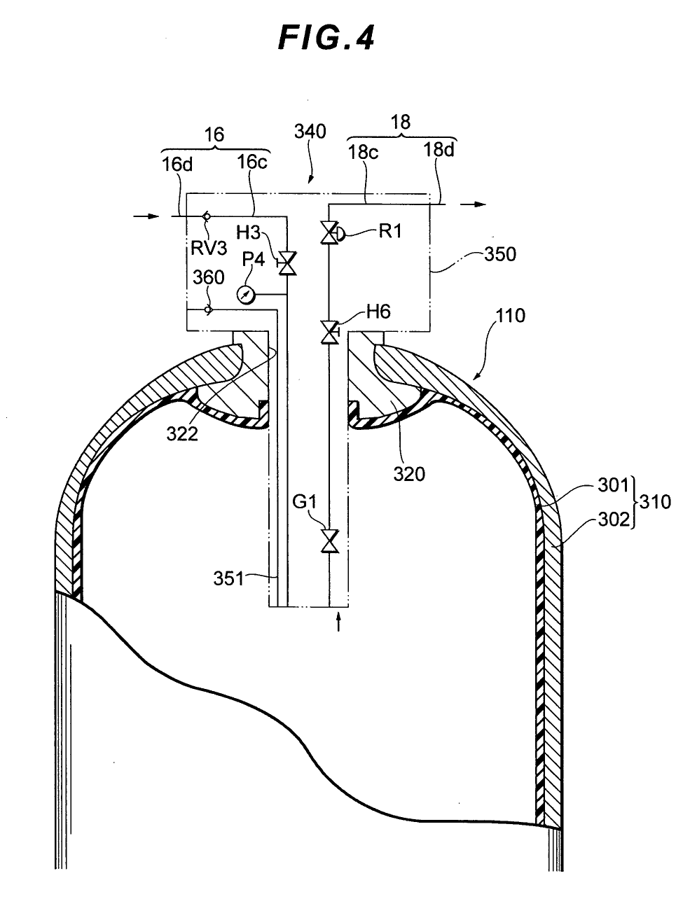

All of the filling tanks 11 to 13 have a similar structure, and are constituted so that the tanks can be filled with the boil-off gas from the fuel tank 10 at the high pressure of a certain degree. These filling tanks 11 to 13 are also provided with relief valves which lower the inner pressure in a case where the inner pressure reaches a predetermined value or more. It is to be noted that structures of the filling tanks 11 to 13 and arrangements of valves will be described later with reference to FIG. 4.

Structures of pipe lines and valves which allow these tanks to communicate with one another will be described. A fuel filling path 16 is laid from a liquid fuel filling port FI to the fuel tank 10, and a filling pipe line 17 is laid from the fuel tank 10 to inlet sides of the filling tanks 11 to 13 so as to provide a structure in which the tanks communicate with one another. On outlet sides of the filling tanks 11 to 13, a first fuel supply path 18 for supplying the boil-off gas from the tanks in common is laid so as to provide the mutually communicating structure, and the first fuel supply path 18 is connected to a second fuel supply path 19 (a main pipe line).

The fuel filling path 16 is a communication path extending from the liquid fuel filling port FI to the fuel tank 10, and is used during the filling with the liquid fuel. In the fuel filling path 16, check valves RV1, RV2, a manual valve H1 and a shut-off valve L1 are arranged in order from the liquid fuel filling port FI. The liquid fuel filling port FI is structured so that the port is connectable to a supply nozzle of a liquid hydrogen filling machine at a liquid fuel stand, and the port is also provided with a connector (not shown) so that the liquid hydrogen filling machine can communicate with the control unit 50 of the fuel cell system 200.

The check valves RV1 and RV2 according to the present invention have a double structure in which the valves are connected in series. Even if a valve defect such as a seal defect is generated in any of the valves, counter flow of liquid hydrogen can be prevented by the check valves. An amount of the fuel gas which resides between the check valves RV1 and RV2 can be reduced as much as possible by setting of a valve opening pressure described later.

Pressure sensors p1 and p2 are arranged so as to measure pressures of sections of the fuel filling path 16 divided by the check valves RV1 and RV2.

The manual valve H1 is a valve for service which is manually opened or closed for regulation during manufacturing or during servicing, and the valve is opened with a predetermined open degree during usual use. The shut-off valve L1 is constituted of an electromagnetic valve which can be controlled to open or close by the control unit 50, and is controlled so as to open during liquid fuel supply. On the inlet side of the fuel tank 10, a pressure sensor p3 for measuring a tank inner pressure, that is, a pressure of the boil-off gas evaporated from liquid hydrogen is arranged, and a temperature sensor t1 for measuring an internal temperature of the boil-off gas is arranged.

The filling pipe line 17 (a filling path) allows the fuel tank 10 to communicate with the filling tanks 11 to 13, and is provided with a manual valve H2 arranged in the vicinity of an outlet of the fuel tank 10. On the inlet side of the filling tank branched into the filling tanks 11 to 13, check valves RV3 to RV5 and manual valves H3 to H5 for the filling tanks are arranged, respectively.

The check valves RV3 to RV5 according to the present invention are configured to automatically open when reaching a predetermined valve opening pressure. The manual valves H3 to H5 are valves for service which are manually opened or closed for the regulation during the manufacturing or during the servicing, and the valves remain to be open with predetermined open degrees during the usual use. At the inlets of the filling tanks 11 to 13, pressure sensors p4 to p6 for measuring pressures of the boil-off gases stored in the tanks are arranged, and temperature sensors t2 to t4 for measuring internal temperatures of the tanks are arranged.

The first fuel supply path 18 allows the filling tanks 11 to 13 to communicate with one another and connects the tanks to the second fuel supply path 19. Branch pipe portions of the first fuel supply path 18 corresponding to the filling tanks 11 to 13 are provided with regulation valves R1 to R3, manual valves H6 to H8 and shut-off valves G1 to G3, respectively. The regulation valves R1 to R3 define pressures to be supplied from the filling tanks 11 to 13 to the first fuel supply path 18, respectively, and the boil-off gases are regulated so as to be output at a predetermined differential pressure. The manual valves H6 to H8 are valves for service which are manually opened or closed for the regulation during the manufacturing or during the servicing, and remain to be open with predetermined open degrees during the usual use.

A part 18a of the first fuel supply path 18 is provided with a shut-off valve L2, and one end portion of the part 18a is connected to the fuel filling path 16 at a connection point A on a downstream side of the two check valves RV1, RV2. That is, the fuel filling path 16 and the first fuel supply path 18 can be bypassed via the shut-off valve L2 (a first shut-off valve). In consequence, the boil-off gas which resides in the fuel filling path 16 is quickly supplied to the first fuel supply path 18 via the shut-off valve L2 and consumed by the fuel cell stack 100. The shut-off valve L2 includes, for example, an electromagnetic valve, and is controlled to open or close by the control unit 50.

It is to be noted that the “fuel supply path” described in the claims is used in a broad sense, refers to a channel from the fuel tank 10 filled with the fuel to the fuel cell stack 100 in which the filled fuel is supplied and consumed, and corresponds to the filling pipe line 17, the first fuel supply path 18, the part 18a of the first fuel supply path and the second fuel supply path 19 in the present embodiment.

From another viewpoint, the “fuel supply path” described in the claims has a “supply path” including a passage of the first fuel supply path 18 except the part 18a and the second fuel supply path 19, a “connection path” including the part 18a of the first fuel supply path 18, and the filling pipe line 17. The “supply path” connects or communicates the filling tanks 11 to 13 as gaseous fuel tanks to the fuel cell stack 100. The “connection path” connects or communicates the “supply path” to the fuel filling path 16. Thus, the “fuel supply path” described in the claims corresponds to the supply path, the connection path and the filling pipe line 17 in the present embodiment.

A constitution of and after the second fuel supply path 19 will be described. In order from an upstream side of the second fuel supply path 19, a gas-liquid separator 14, a shut-off valve L4, a hydrogen pump 15 and a purge shut-off valve L5 are arranged via pressure regulating valves R4, R5, a shut-off valve L3 and a channel of the fuel cell stack 100. A part (on the downstream side of the shut-off valve L3) of the second fuel supply path 19 constitutes a circulation path of a hydrogen gas which circulates and supplies the hydrogen gas through the fuel cell stack 100.

The pressure regulating valves R4, R5 are configured to regulate the pressure of the boil-off gas from the first fuel supply path 18 and output the gas. The pressure regulating valves R4 and R5 are constituted of double diaphragms in order to cope with the seal defect. Each of the pressure regulating valves R4 and R5 is provided with a relief valve in the vicinity thereof in order to reduce the pressure in a case where the inside of the pipe line reaches a pressure which is not less than a predetermined pressure. The shut-off valve L3 opens or closes in response to start or stop of power generation, and is constituted so that presence of supply of the boil-off gas can be controlled along the second fuel supply path 19. A pressure sensor p10 is arranged so that the inner pressure of the first fuel supply path 18 can be measured, a pressure sensor p11 is arranged so that the inner pressure between the pressure regulating valves R4 and R5 can be measured, a pressure sensor p12 is arranged so that the inner pressure of the fuel cell stack 100 can be measured and a pressure sensor p13 is arranged so that the pressure at an inlet of the hydrogen pump 15 can be measured.

The fuel cell stack 100 includes a stack structure in which a plurality of power generation structures referred to as single cells are stacked. Each single cell includes a structure in which a power generation member referred to as a membrane electrode assembly (MEA) is nipped between a pair of separators provided with channels of the hydrogen gas (the boil-off gas), air and cooling water. The MEA is constituted by nipping a polymer electrolytic film between two electrodes of an anode and a cathode. The anode is constituted by disposing a catalytic layer for the anode on a porous support layer, and the cathode is constituted by disposing a catalytic layer for the cathode on the porous support layer.

The boil-off gas supplied to the anode of the fuel cell stack 100 is supplied to each single cell via a manifold, and flows through the fuel gas channels of the separators to cause an electrochemical reaction in the anode of the MEA. The boil-off gas (a hydrogen-off gas) discharged from the fuel cell stack 100 is supplied to the gas-liquid separator 14. The gas-liquid separator 14 is configured to remove, from the hydrogen-off gas, water content and other impurities generated owing to the electrochemical reaction of the fuel cell stack 100 during a usual operation and to release the water content and impurities to the outside through the shut-off valve L4. The hydrogen pump 15 forcibly circulates the hydrogen-off gas and returns the gas to the second fuel supply path 19 to constitute the circulation path. The purge shut-off valve L5 is opened during purging, but is shut off in a usual operation state and during judgment of gas leakage from the pipe line. The hydrogen-off gas purged from the purge shut-off valve L5 is treated by an exhaust system including a dilution unit 25.

The air supply system 2 includes an air cleaner 21, a compressor 22, a humidifier 23, a gas-liquid separator 24, the dilution unit 25 and a muffler 26. The air cleaner 21 purifies outside air to introduce the air into a fuel power system. The compressor 22 is configured to change an amount and a pressure of the introduced air to be compressed and supplied under control of the control unit 50. The air supplied to the cathode of the fuel cell stack 100 is supplied to each single cell via the manifold in the same manner as in the boil-off gas, and flows through the air channels of the separators to cause the electrochemical reaction in the cathode of the MEA. The humidifier 23 of the air (an air-off gas) discharged from the fuel cell stack 100 performs heat exchange between the air-off gas and the water content to add appropriate humidity to the compressed air. The air supplied to the fuel cell stack 100 is supplied to each single cell via the manifold, and flows through the air channels of the separators to cause the electrochemical reaction in the cathode of the MEA. Excessive water content is removed from the air-off gas discharged from the fuel cell stack 100 by the gas-liquid separator 24. The dilution unit 25 is configured to mix and dilute the hydrogen-off gas supplied from the purge shut-off valve L5 with the air-off gas and to homogenize the gas so as to obtain a concentration at which any oxidizing reaction is not caused. The muffler 26 is constituted so that a noise level of the mixed exhaust gas can be reduced to discharge the gas.

The cooling system 3 includes a radiator 31, a fan 32, a cooling pump 33, a cooling device 34 and rotary valves C1 to C4. The radiator 31 includes a large number of pipe lines, and a branched cooling liquid is forcibly cooled by the air blown by the fan 32. The cooling pump 33 circulates and supplies the cooling liquid through the fuel cell stack 100. The cooling liquid which has entered the fuel cell stack 100 is supplied to each single cell via the manifold, and flows through the cooling liquid channels of the separators to take heat generated by power generation. The cooling device 34 includes a capacitor and the like, has a cooling performance in excess of an air cooling performance, and can lower a temperature of the cooling liquid.

The cooling system 3 can switch the rotary valve C1 or C2 to select any one from cooling paths 35 to 37. The cooling path 35 is a path which supplies the cooling liquid to the cooling pump 33 without cooling the liquid with the air by the radiator 31, and the cooling path 36 is a path to forcibly cool the liquid with the air by the radiator 31. The cooling path 37 is a circulation path to cool the filling tanks 11 to 13 of the present invention. The rotary valve C1 switches the path to the cooling path 37 for the filling tanks 11 to 13 or the cooling paths 35 and 36. The rotary valve C2 switches whether to pass the circulated cooling liquid from the filling tanks 11 to 13 through the cooling path 35 in which the air cooling is not performed or the cooling path 36 in which the air cooling is performed. The cooling path 37 is provided with the rotary valves C3 and C4. The rotary valve C3 is configured to select whether or not to supply the cooling liquid to the filling tank 11, and the rotary valve C4 is configured to select whether or not to supply the cooling liquid to the filling tank 12. The cooling path 37 is provided with a pipe line so that areas close to the inlet and outlet of the boil-off gas of the filling tanks 11 to 13 (areas close to the check valves RV3 to RV5 and the regulation valves R1 to R3) can be cooled. The temperature of the boil-off gas can be controlled to reduce the pressure of the gas.

Especially, the rotary valves C1 and C2 are controlled so as to circulate the cooling liquid through the cooling path 35 during start. During the start, the cooling liquid is prevented from flowing through the radiator 31 and the filling tanks 11 to 13. In consequence, destruction is inhibited by thermal shock caused by supplying the cooling liquid having a large temperature difference.

The power system 4 includes a DC-DC converter 40, a battery 41, a traction inverter 42, a traction motor 43, an auxiliary inverter 44, a high-pressure auxiliary machine 45 and the like. The fuel cell stack 100 is constituted by connecting the single cells in series, and a predetermined high-pressure voltage (e.g., about 500 V) is generated between an anode A and a cathode C of the stack. The DC-DC converter 40 bidirectionally converts the voltage between the converter and the battery 41 which has a terminal voltage different from an output voltage of the fuel cell stack 100, and power of the battery 41 can be used as an auxiliary power source of the fuel cell stack 100, of the battery 41 can be charged with surplus power from the fuel cell stack 100. The DC-DC converter 40 can set the voltage between the terminals in response to the control of the control unit 50. The battery 41 is constituted by laminating battery cells, and a constant high voltage is set as a terminal voltage. Under control of a battery computer (not shown), the battery can be charged with the surplus power, and can auxiliary supply the power. The traction inverter 42 converts a direct current into a three-phase alternating current to supply the current to the traction motor 43. The traction motor 43 is, for example, a three-phase motor, and is a main power source of a car on which the fuel cell system 200 is mounted. The auxiliary inverter 44 is direct current-alternating current conversion means for driving the high-pressure auxiliary machine 45. The high-pressure auxiliary machine 45 includes various motors required for an operation of the fuel cell system 200 including the compressor 22, the hydrogen pump 15, the fan 32, the cooling pump 33 and the like.

The control unit 50 includes a constitution of a general-purpose computer including an RAM, an ROM, an interface circuit and the like. The control unit 50 can successively execute a software program stored in a built-in ROM or the like to mainly control the whole fuel cell system 200 including the hydrogen gas supply system 1, the air supply system 2, the cooling system 3 and the power system 4.

Especially in the present embodiment, the check valves RV1 and RV2 arranged in the fuel filling path 16 are characterized in that a valve opening pressure Po2 of the check valve RV2 arranged on a fuel tank 10 side is set to be smaller than a valve opening pressure Po1 of the check valve RV1 arranged on a filling port FI side (Po1>Po2). Since the pressures are set in this manner, the check valve RV2 arranged on the downstream side (the fuel tank 10 side) opens at a pressure lower than that of the check valve RV1 arranged on the upstream side (the filling port FI side). When the pressure of the fuel filling path 16 drops after the filling ends, the check valve RV1 on the upstream side first closes, and the fuel gas which has resided between the check valves RV1 and RV2 is discharged to the fuel filling path 16 on the downstream side via the check valve RV2 on the downstream side which is not closed. Therefore, the fuel gas can be inhibited from residing between the check valves RV1 and RV2.

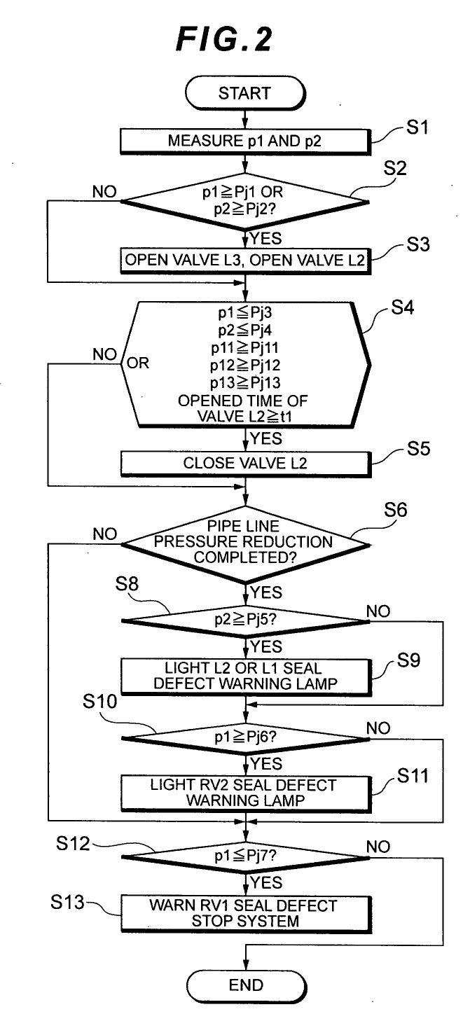

A use process of the fuel tank residual gas of the present embodiment will be described with reference to a flow chart shown in FIG. 2. Since the valve opening pressures of the check valves RV1 and RV2 are set according to the present invention, the fuel gas between the check valves RV1 and RV2 flows on the downstream side of the check valve RV2, in a case where the tank is not filled with liquid hydrogen. The control unit 50 measures a pressure p1 between the check valves RV1 and RV2 and a pressure p2 of the fuel filling path 16 between the check valve RV2 and the shut-off valve L1 (S1), and determines whether the pressure p1 between the check valves RV1 and RV2 is not less than a predetermined pressure Pj1 or whether the pressure p2 between the check valve RV2 and the shut-off valve L1 is not less than a predetermined pressure Pj2 (S2). As a result, in a case where the pressure p1 or p2 exceeds a predetermined pressure (S2; YES), the control unit 50 opens the shut-off valve L2 for the communication with the first fuel supply path 18 and the shut-off valve L3 which controls the circulation through the second fuel supply path 19 (S3). According to this process, the fuel gas which resides between the check valves RV1 and RV2 and which is discharged from the check valve RV2 having a small valve opening pressure to the fuel filling path 16 further passes through the shut-off valves L2 and L3, and is supplied to the fuel cell stack 100. It is to be noted that the shut-off valve L2 corresponds to the “first shut-off valve” described in the claims.

Subsequently, a timing to close the shut-off valve L2 is judged based on transitions of the pressures p1 and p2, the inner pressures of the first fuel supply path 18 and the second fuel supply path 19 and a valve opened time of the shut-off valve L3. That is, in a case where the pressure p1 between the check valves RV1 and RV2 is not more than a predetermined pressure Pj3 or the pressure p2 between the check valve RV2 and the shut-off valve L1 is not more than a predetermined pressure pj4, it is judged that the pressure of the fuel filling path 16 sufficiently drops and that almost all the residual fuel gas has been supplied to the fuel cell stack 100. In a case where inner pressures p11, p12 and p13 of the first fuel supply path 18 and the second fuel supply path 19 are not less than any of predetermined values Pj11, Pj12 and Pj13, it is indicated that the inner pressures of the first fuel supply path 18 and the second fuel supply path 19 rise and that the residual fuel gas is supplied to the fuel cell stack 100. In a case where the valve opened time of the shut-off valve L2 is not less than a predetermined time t1, it can be judged that a time sufficient for discharging the residual fuel gas from the fuel filling path 16 having a comparatively small capacity has elapsed. In consequence, when any of these conditions is satisfied (S4: YES), the control unit 50 opens the shut-off valve L2 (S5).

Subsequently, it is checked whether or not the residual fuel gas has sufficiently been discharged from the fuel filling path 16, that is, whether or not the pressure of the pipe line has completely been reduced. When the pressure reduction of the pipe line is completed (S6: YES), the process shifts to detection of the seal defect or the like of the valves arranged in the fuel filling path 16. First, in a case where the pressure p2 of the fuel filling path 16 between the check valve RV2 and the shut-off valve L1 is high to a certain degree, it is indicated that a comparatively large amount of the fuel gas is present in the fuel filling path 16 on the downstream side of the check valve RV2. The process to supply the residual fuel gas to the fuel cell stack 100 has already ended. Therefore, in such a case, it is considered that the shut-off valve L2 or L1 has a seal defect. Therefore, when the pressure p2 is not less than a predetermined pressure Pj5 (S8: YES), a warning lamp or the like indicating the seal defect of the shut-off valve L2 or L1 is lit (S9). It is to be noted that the shut-off valve L1 corresponds to a “second shut-off valve” described in the claims.

On the other hand, in a case where the pressure p1 between the check valves RV1 and RV2 is high to a certain degree, it is indicated that the fuel gas on the downstream side flows backward through the check valve RV2 in a section where the pressure should originally sufficiently be reduced. A cause for this is considered to be the seal defect of the check valve RV2. Therefore, when the pressure p1 is not less than a predetermined pressure Pj6 (S10: YES), a warning lamp or the like indicating the seal defect of the check valve RV2 is lit (S11).

On the other hand, the pressure p1 between the check valves RV1 and RV2 must substantially be kept at the valve opening pressure set to the check valve RV2, in a case where these check valves normally operate. If the pressure p1 becomes smaller than the valve opening pressure of this check valve RV2, there is then a possibility that the pressure comes close to an outside air pressure owing to the seal defect of the check valve RV1 on the upstream side or the like. Therefore, in a case where the pressure p1 is not more than a predetermined pressure Pj7 which is smaller than the valve opening pressure set to the check valve RV2 (S12: YES), it is judged that the check valve RV1 on the upstream side has the seal defect, a warning is issued that an operation defect might be generated in the check valve RV1, and a stop sequence of the fuel cell system 200 is executed if necessary (S13).

As described above, according to the present embodiment, since the check valve RV2 arranged on the downstream side opens at a pressure lower than that of the check valve RV1 arranged on the upstream side, the fuel gas is inhibited from residing between the check valves, and the fuel gas can effectively be used.

Moreover, according to the present embodiment, the shut-off valve L2 (L3) is opened in a case where the inner pressure of the fuel filling path 16 rises. Therefore, the fuel gas which resides in the fuel filling path 16 is supplied to the fuel cell stack 100 which is a fuel consumption device via the first fuel supply path 18 and the second fuel supply path 19, and the gas can effectively be consumed.

Furthermore, according to the present embodiment, the closing of the shut-off valve L2 is controlled based on the pressure changes of the first fuel supply path 18 and the second fuel supply path 19 and the valve opened time of the shut-off valve L2. Therefore, regardless of generation of a valve defect, a temporary communication state between the fuel filling path 16 and the first fuel supply path 18 can be cancelled at once.

In addition, according to the present embodiment, it is constituted that the inner pressure between the check valve RV2 and the shut-off valve L1 at the inlet of the fuel tank 10 is monitored. If a defect is generated in the shut-off valve L1 (L2), the fuel gas stored in the fuel tank 10 leaks and flows backward to change the inner pressure of the fuel filling path 16. According to the present invention, it is constituted that a value of this inner pressure is monitored. Therefore, the defect of the shut-off valve L1 can correctly be detected.

Moreover, according to the present embodiment, when the shut-off valve L2 opens or closes to end the reduction of the pressure of the fuel filling path 16, the inner pressure between the check valves RV1 and RV2 which are continuously arranged is monitored. The check valve RV2 is shut off, when the residual fuel gas is discharged and the pressure drops below the valve opening pressure. If the defect is generated in the check valve RV2, the inner pressure between the check valves RV1 and RV2 rises even after releasing the residual fuel gas. The defect of the check valve RV2 on the downstream side can be detected based on this inner pressure between the check valves RV1 and RV2.

### (Modification)

The present invention may variously be modified and applied without being limited to the above embodiment.

For example, in the above embodiment, liquid hydrogen is described as an example of the liquid fuel to be handled. However, if a gas-phase fuel is included, the present invention is similarly applicable. The liquid fuel may be, for example, a liquefied natural gas.

Moreover, the two check valves RV1, RV2 arranged in the fuel filling path 16 have been described. However, needless to say, two or more check valves may be arranged. When three or more check valves are arranged, the valve opening pressures of the check valves may be set so that the pressures are reduced in order from the upstream side (the filling port FI side) to the downstream side (the fuel tank 10 side). It is to be noted that the two check valves may be arranged in the fuel filling path 16 as in the present embodiment, arranged in the vicinity (e.g., a tank mouthpiece) of the fuel tank 10, or arranged at least one of these positions.

Furthermore, the present invention is not limited to one fuel tank 10, and a plurality of fuel tanks may be arranged.

### Second Embodiment

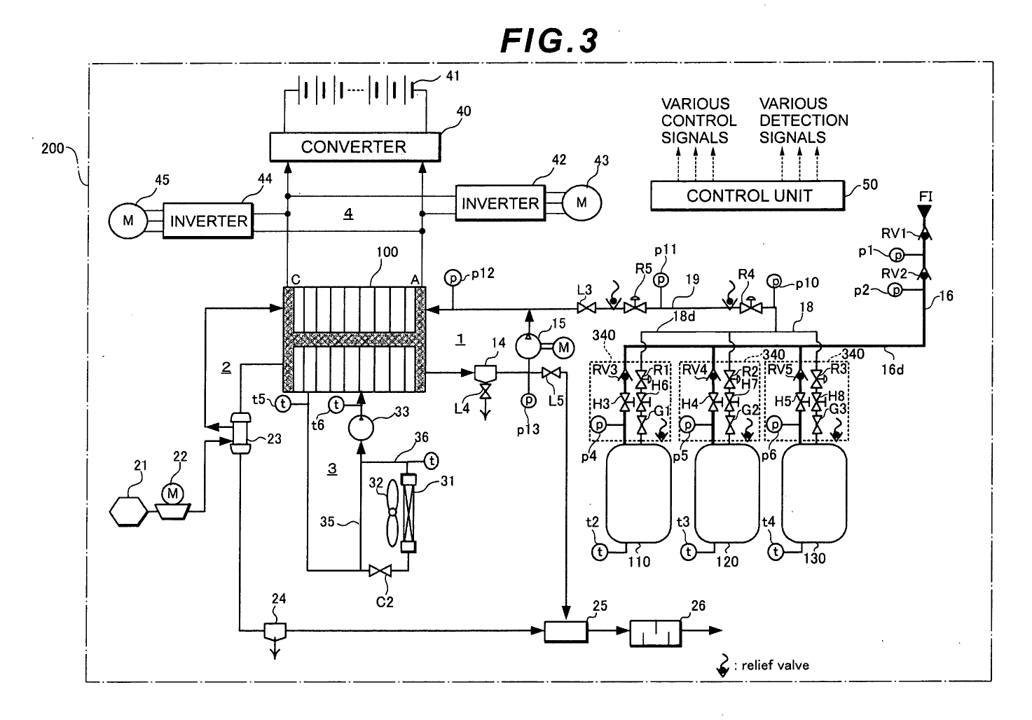

Next, a fuel cell system 200 to which a fuel tank system is applied according to a second embodiment of the present invention will be described mainly in relation to a different respect from the first embodiment with reference to FIGS. 3 and 4. In the present embodiment, instead of using liquid hydrogen, fuel tanks 110 to 130 (corresponding to the filling tanks of the first embodiment) are directly filled with a hydrogen gas from the outside, and this filled hydrogen gas is supplied to a fuel cell stack 200. In the following description, the same components, devices or systems as those of the first embodiment are denoted with the same reference numerals as those of the first embodiment, and detailed description thereof is appropriately omitted.

FIG. 3 is a system block diagram of the fuel cell system 200 according to the second embodiment.

The fuel cell system 200 is mounted on a mobile object such as a car, and includes a fuel cell stack 100, a hydrogen gas supply system 1, an air supply system 2, a cooling system 3, a power system 4 and a control unit 50.

The hydrogen gas supply system 1 includes a plurality of fuel tanks 110 to 130 as gaseous fuel tanks to be filled with the fuel gas supplied from the outside via a filling port FI. All of the fuel tanks 110 to 130 include a similar structure, and are configured to have the same structures as those of the filling tanks 11 to 13 of the first embodiment, but are different in arrangements of valves as described later.

A fuel filling path 16 allows the fuel filling port FI to communicate with inlet sides of the fuel tanks 110 to 130, and is used during the filling with the fuel gas. On outlet sides of the fuel tanks 110 to 130, a first fuel supply path 18 for supplying the fuel gas from each tank in common is laid so as to provide a structure in which the tanks communicate with one another, and the first fuel supply path 18 is connected to a second fuel supply path 19 (a main pipe line).

The fuel filling port FI is structured so that the port is connectable to a supply nozzle of a hydrogen gas filling machine at a fuel gas stand or the like. The fuel filling path 16 is provided with check valves RV1, RV2 in order from the fuel filling port FI at positions away from the fuel tanks 110 to 130. The check valves RV1 and RV2 according to the present invention have a double structure in which the valves are connected in series. The check valves RV1 and RV2 permit a flow of the fuel gas from the fuel filling port FI to the fuel tanks 110 to 130, and inhibit a counter flow of the gas. An amount of the fuel gas which resides between the check valves RV1 and RV2 can be reduced as much as possible by setting of a valve opening pressure described later. Pressure sensors p1 and p2 are arranged so as to measure pressures of sections of the fuel filling path 16 divided by the check valves RV1 and RV2.

On an inlet side of the fuel tank branched into the fuel tanks 110 to 130, the fuel filling path 16 is provided with check valves RV3 to RV5 and manual valves H3 to H5 for the fuel tanks 110 to 130, respectively. The check valves RV3 to RV5 according to the present invention are configured to automatically open when reaching a predetermined valve opening pressure. At inlets of the fuel tanks 110 to 130, pressure sensors p4 to p6 and temperature sensors t2 to t4 are arranged.

Branch pipe portions of the first fuel supply path 18 corresponding to the fuel tanks 110 to 130 are provided with regulation valves R1 to R3, manual valves H6 to H8 and shut-off valves G1 to G3, respectively. The regulation valves R1 to R3 reduce pressures of the fuel gas. The shut-off valves G1 to G3 are constituted of, for example, electromagnetic valves, and controlled to open or close by the control unit 50.

Here, specific structures of the fuel tanks, the arrangements of the valves and the like will be described in accordance with the fuel tank 110 as an example with reference to FIG. 4.

The fuel tank 110 includes a vessel main body 310 including a liner 301 and a shell 302 disposed outside the liner, and a mouthpiece 320 attached to one end portion of the vessel main body 2 in a longitudinal direction. The vessel main body 310 is constituted so that a high-pressure fuel gas, for example, a hydrogen gas of 35 MPa or 70 MPa can be stored. It is to be noted that, when the fuel gas is a compressed natural gas (the CNG gas), the vessel main body 310 stores, for example, the CNG gas of 20 MPa. The vessel main body 310 is formed by insertion molding in which the mouthpiece 320 is inserted into the center of an end wall portion of the body having a semispherical shape. A female screw 322 is formed on an inner peripheral surface of an opening of the mouthpiece 320, and a valve assembly 340 is screwed and connected to this female screw.

The valve assembly 340 is a module in which, in addition to a gas passage, pipe line elements such as a valve and a joint, various gas separators and the like are integrally incorporated in a housing 350. The valve assembly 10 is arranged so as to extend internally and externally with respect to the fuel tank 110. An outer peripheral surface of a neck portion of the housing 350 is provided with a male screw to be engaged with the female screw 322. In the screw connected state, a gap between the housing 350 and the mouthpiece 320 is air-tightly sealed with a plurality of seal members (not shown).

In the housing 350, a channel 16c of a part of the fuel filling path 16, a channel 18c of a part of the first fuel supply path 18 and a relief channel 351 are formed. The channel 16c allows the inside of the vessel main body 310 to communicate with the filling port FI via an external pipe line 16d of the fuel filling path 16. The channel 16c is provided with the check valve RV3, the manual valve H3 and the pressure sensor P4 described above. The channel 16c may be provided with a plurality of check valves RV3, and a plurality of check valves may be attached to the fuel tank 110. The channel 18c allows the inside of the vessel main body 310 to communicate with the second fuel supply path 19 via an external pipe line 18d of the first fuel supply path 18. The channel 18c is provided with the shut-off valve G1, the manual valve H6 and the regulation valve R1 described above. The relief channel 351 is provided with a relief valve 360 which lowers an inner pressure in a case where the inner pressure of the fuel tank 110 reaches a predetermined value or more. It is to be noted that arrangements (upstream and downstream) of the shut-off valve G1 and the regulation valve R1 may be inversed.

The embodiment will be described again with reference to FIG. 3.

A constitution of and after a second fuel supply path 19 is similar to that of the first embodiment. That is, in order from an upstream side of the second fuel supply path 19, a gas-liquid separator 14, a shut-off valve L4, a hydrogen pump 15 and a purge shut-off valve L5 are arranged via pressure regulating valves R4, R5, a shut-off valve L3 and a channel of the fuel cell stack 100. The pressure of the fuel gas stored in the fuel tanks 110 to 130 is reduced with the regulation valves R1, R4 and R5 in a stepwise manner, and the gas is supplied to the fuel cell stack 100 in a pressure state of approximately 1 MPa. The second fuel supply path 19 is also provided with pressure sensors p11 to p13.

The air supply system 2 includes an air cleaner 21, a compressor 22, a humidifier 23, a gas-liquid separator 24, a dilution unit 25 and a muffler 26 in the same manner as in the first embodiment. In the present embodiment, the cooling system 3 includes a radiator 31, a fan 32, a cooling pump 33 and a rotary valve C2. It is to be noted that the cooling system 2 may include a cooling device 34, cooling paths 35 to 37 and rotary valves C1, C3 and C4 in the same manner as in the first embodiment. Furthermore, the power system 4 includes a DC-DC converter 40, a battery 41, a traction inverter 42, a traction motor 43, an auxiliary inverter 44, a high-pressure auxiliary machine 45 and the like.

The control unit 50 includes a constitution of a general-purpose computer including an RAM, an ROM, an interface circuit and the like. The control unit 50 can successively execute a software program stored in a built-in ROM or the like to mainly control the whole fuel cell system 200 including the hydrogen gas supply system 1, the air supply system 2, the cooling system 3 and the power system 4.

In the present embodiment, the check valves RV1 and RV2 arranged in the fuel filling path 16 are characterized in that a valve opening pressure Po2 of the check valve RV2 arranged on a side of the fuel tanks 110 to 130 is set to be smaller than a valve opening pressure Po1 of the check valve RV1 arranged on a filling port FI side (Po1>Po2). Since the pressures are set in this manner, the check valve RV2 on the downstream side opens at a pressure lower than that of the check valve RV1 on the upstream side. When the pressure of the fuel filling path 16 drops after the filling ends, the check valve RV1 on the upstream side first closes, and the fuel gas which has resided between the check valves RV1 and RV2 is discharged to the fuel filling path 16 on the downstream side via the check valve RV2 on the downstream side which is not closed. Therefore, the fuel gas can be inhibited from residing between the check valves RV1 and RV2.

Similarly, in relation to the check valve RV2 and the check valves RV3 to RV5, valve opening pressures Po3 to Po5 of the check valves RV3 to RV5 are set to be smaller than the valve opening pressure Po2 of the check valve RV2 on the upstream side as represented by the following formulas:

Po2>Po3;

Po2>Po4; and

Po2>Po5

In this case, when the pressure of the fuel filling path 16 drops after the filling ends, the check valves RV1, RV2 close in order, and then the check valves RV3 to RV5 close. Therefore, the fuel gases which have resided between the check valves RV2 and RV3, between the check valves RV2 and RV4 and between the check valves RV2 and RV5 are discharged to the fuel filling path 16 on the downstream side via the check valves RV3 to RV5 on the downstream side which are not closed. Therefore, the fuel gas can be inhibited from residing between the check valve RV2 and the check valves RV3 to RV5.

As described above, according to the present embodiment, in the same manner as in the first embodiment, the plurality of check valves of the fuel filling path 16 close in order from the upstream side of the path. Therefore, the fuel gas can be inhibited from residing between the check valve, and the fuel gas can effectively be used.

### INDUSTRIAL APPLICABILITY

As described above, the present invention is applicable to not only mobile objects such as a vehicle, a ship and an airplane on which a fuel cell system 200 is mounted but also the fuel cell system 200 fixedly installed in closed spaces such as a building and a house. Namely, this is because the invention has a constitution usable in a system in which a fuel gas is used while being replenished.

Moreover, in the above-described embodiments, the fuel cell system 200 has been described as an example of a system to which a fuel tank system is applied. Needless to say, the fuel tank system may include another fuel consumption device different from a fuel cell stack 100. Examples of the other fuel consumption device may include a hydrogen engine (an internal combustion engine) which consumes a hydrogen gas evaporated from liquid hydrogen and a natural gas engine which consumes a natural gas evaporated from a liquefied natural gas.

1. A fuel tank system having a fuel filling path to supply fuel to a fuel tank through a filling port, comprising:
at least two check valves arranged in series in the fuel filling path,
wherein a valve opening pressure of one check valve arranged on the fuel tank side is set to be smaller than that of the other check valve arranged on the filling port side.

2. The fuel tank system according to claim 1, further comprising:
a fuel consumption device configured to consume the fuel;
a fuel supply path configured to provide a fluid communication between the fuel consumption device and the fuel filling path; and
a first shut-off valve arranged in the fuel supply path,
wherein the first shut-off valve is opened by an inner pressure of the fuel filling path.

3. The fuel tank system according to claim 2, wherein the fuel supply path is fluidly connected to the fuel filling path on a downstream side of at least the two check valves.

4. The fuel tank system according to claim 2, wherein the first shut-off valve is opened based on the inner pressure between at least the two check valves in the fuel filling path.

5. The fuel tank system according to claim 2, wherein the first shut-off valve is opened based on the inner pressure on the downstream side of at least the two check valves in the fuel filling path.

6. The fuel tank system according to claim 2, wherein the fuel is liquid fuel and the fuel tank is a liquid fuel tank to store the liquid fuel,
the fuel tank system further comprising:
a gas fuel tank for storing gaseous fuel evaporating from the liquid fuel stored in the liquid fuel tank; and
a filling path for providing a fluid communication between the liquid fuel tank and the gas fuel tank, the filling path filling the gas fuel tank with the gaseous fuel from the liquid fuel tank,
wherein the fuel supply path has a supply path which provides a fluid communication between the gas fuel tank and the fuel consumption device and,
the fuel consumption device is configured to consume the gaseous fuel.

7. The fuel tank system according to claim 6, wherein a plurality of gas fuel tanks are arranged,
the filling path provides a fluid communication between the liquid fuel tank and the plurality of gas fuel tanks, and
the supply path provides a fluid communication between the plurality of gas fuel tanks and the fuel consumption device.

8. The fuel tank system according to claim 6, wherein the first shut-off valve is closed based on a pressure in the supply path.

9. The fuel tank system according to claim 2, wherein the first shut-off valve is closed based on a pressure in the fuel supply path.

10. The fuel tank system according to claim 2, wherein the first shut-off valve is closed based on a valve opened time of the first shut-off valve.

11. The fuel tank system according to claim 2, further comprising:
a second shut-off valve arranged at an inlet of the fuel tank in the fuel filling path; and
a control unit which determines whether or not the second shut-off valve is defective based on an inner pressure between the check valve arranged on the fuel tank side and the second shut-off valve, in a case where reduction in the pressure of the fuel filling path is completed by opening or closing the first shut-off valve.

12. The fuel tank system according to claim 2, further comprising:
a control unit which determines whether or not the check valve arranged on the downstream side of the fuel filling path is defective based on an inner pressure between the continuously arranged check valves, in a case where reduction in the pressure in the fuel filling path is completed by opening or closing the first shut-off valve.

13. The fuel tank system according to claim 1, wherein at least the two check valves comprise at least one check valve attached to the fuel tank, and at least one check valve arranged at a position away from the fuel tank.

14. The fuel tank system according to claim 13, wherein at least one check valve attached to the fuel tank is incorporated in a valve assembly connected to a mouthpiece of the fuel tank.

15. The fuel tank system according to claim 1, wherein a plurality of fuel tanks are provided in the fuel tank system.

16. The fuel tank system according to claim 1, wherein the fuel is a gaseous fuel.

17. The fuel tank system according to claim 16, further comprising:
a fuel cell which consumes the gaseous fuel; and
a supply path which provides a fluid communication between the fuel cell and the fuel tank.
